(19) United States
(12) Patent Application Publication
(10) Pub. No.: US 2023/0239192 A1
(43) Pub. Date: Jul. 27, 2023

(54) ADJUSTING ORTHOGONAL FREQUENCY DIVISION MULTIPLEXED WAVEFORMS USING SELECTED SUBCARRIERS

(71) Applicant: SKYWORKS SOLUTIONS, INC., Irvine, CA (US)

(72) Inventors: Grant Darcy POULIN, Carp (CA); William J. DOMINO, Yorba Linda, CA (US)

(21) Appl. No.: 18/101,089

(22) Filed: Jan. 24, 2023

Related U.S. Application Data
(60) Provisional application No. 63/303,840, filed on Jan. 27, 2022.

(51) Int. Cl. H04L 27/26; H04L 5/00; H04W 72/0453

(52) U.S. Cl. CPC H04L 27/2666; H04L 5/0048; H04W 72/0453; H04L 5/0007

(57) ABSTRACT

In some embodiments, a method for multiplexing signals can include providing multiple subcarriers, selecting a group of one or more subcarriers among the multiple subcarriers, and adjusting each subcarrier of the selected group. The method can further include performing a multiplexing operation with the multiple subcarriers to obtain an output signal, with the output signal having an adjusted property resulting from the adjusting of the one or more subcarriers of the selected group. In some embodiments, the multiple subcarriers can include one or more groups of data subcarriers and one or more groups of guard band subcarriers.

### CROSS-REFERENCE TO RELATED APPLICATION(S)

This application claims priority to U.S. Provisional Application No. 63/303,840 filed Jan. 27, 2022, entitled ADJUSTING ORTHOGONAL FREQUENCY DIVISION MULTIPLEXED WAVEFORMS USING SELECTED SUBCARRIERS, the disclosure of which is hereby expressly incorporated by reference herein in its respective entirety.

### BACKGROUND

### Field

The present disclosure relates to circuits, systems, devices and methods for adjusting orthogonal frequency division multiplexed waveforms.

### Description of the Related Art

A frequency division multiplexing (FDM) involves a frequency band that includes a plurality of signals based on respective subcarrier tones. In such a multiplexing scheme, the frequencies of the subcarrier tones are separated sufficiently to avoid overlapping of neighboring signals. Accordingly, there is a limit on how closely subcarriers can be packed within a given frequency band width.

An orthogonal frequency division multiplexing (OFDM) scheme involves a frequency band that includes more densely packed subcarriers, such that neighboring pairs of signals based on respective subcarrier tones may overlap. To accommodate the densely packed subcarriers, each subcarrier can be modulated with a digital modulation scheme, such that the subcarriers behave as orthogonal subcarriers.

### SUMMARY

In accordance with some implementations, the present disclosure relates to a method for multiplexing signals. The method includes providing multiple subcarriers, selecting a group of one or more subcarriers among the multiple subcarriers, and adjusting each subcarrier of the selected group. The method further includes performing a multiplexing operation with the multiple subcarriers to obtain an output signal, with the output signal having an adjusted property resulting from the adjusting of the one or more subcarriers of the selected group.

In some embodiments, the multiple subcarriers can include one or more groups of data subcarriers and one or more groups of guard band subcarriers. The one or more groups of data subcarriers can include first and second groups of data subcarriers. The selected group can include some or all of the guard band subcarriers.

In some embodiments, the multiple subcarriers can further include a DC subcarrier implemented between the first group of data subcarriers and the second group of data subcarriers. In some embodiments, the selected group can further include the DC subcarrier.

In some embodiments, the selected group does not include any data subcarriers. In some embodiments, the selected group can include a portion of the data carriers.

In some embodiments, the adjusting of each subcarrier of the selected group can include providing a non-zero amplitude and a phase to each subcarrier of the selected group. The non-zero amplitude can include a fixed amplitude for all of the subcarriers of the selected group. The non-zero amplitude can be selected to be greater than the largest amplitude among the data subcarriers.

In some embodiments, the phase provided to each subcarrier of the selected group can include a selected phase obtained from an iterative process where phase is allowed to vary, with the selected phase corresponding to an output having a desired property resulting from a multiplexing operation with the selected phase provided for each subcarrier of the selected group.

In some embodiments, the non-zero amplitude and the phase provided to each subcarrier of the selected group can be tailored to generate one or more peaks in a time domain signal with each peak having a phase that cancels some or all of a corresponding peak identified in an uncorrected time domain signal.

In some embodiments, the adjusted property of the output signal can include an adjusted peak to average power ratio (PAPR). The adjusted PAPR can include a reduced PAPR. In some embodiments, the method can further include providing the output signal with the reduced PAPR to a power amplifier to obtain an amplified signal.

In some embodiments, the amplified signal can be obtained with some or all of an improved power amplification efficiency, an improved error vector magnitude (EVM) performance, and an improved adjacent channel power ratio (ACPR) performance, when compared to an amplified signal resulting from amplification of an output of a multiplexing operation without adjustment of the one or more subcarriers of the selected group.

In some embodiments, the multiplexing operation can include an orthogonal frequency division multiplexing (OFDM) operation.

In some implementations, the present disclosure relates to a method for determining an adjustment for a multiplexing operation. The method includes selecting a group of one or more subcarriers among multiple subcarriers including data subcarriers and guard band subcarriers, and performing a plurality of multiplexing operations with the multiple subcarriers to obtain respective output signals, with each multiplexing operation being performed with the one or more subcarriers of the selected group having a variation. The method further includes selecting an output signal that provides a desired property, and setting an adjustment value for each subcarrier of the selected group based on the multiplexing operation that provided the output signal with the desired property.

In some embodiments, the method can further include performing a multiplexing operation with the multiple subcarriers to obtain an output signal for amplification, with the multiplexing operation being performed with each subcarrier of the selected group being adjusted with the adjustment value.

In some embodiments, the performing of the plurality of multiplexing operations, the selecting of the output signal with the desired property, and the setting of the adjustment value can be performed prior to the performing of the multiplexing operation for providing the output signal for amplification.

According to some implementations, the present disclosure relates to a multiplexing system that includes a digital circuitry configured to provide multiple subcarriers that include data subcarriers and guard band subcarriers. The system further includes a controller configured to adjust each subcarrier of a selected group of one or more subcarriers among the multiple subcarriers, and perform a multiplexing operation with the multiple subcarriers to obtain an output signal, such that the output signal has an adjusted property resulting from the adjustment of the one or more subcarriers of the selected group.

In some embodiments, the multiplexing system can be an orthogonal frequency division multiplexing (OFDM) system.

In some implementations, the present disclosure relates to a multiplexing system that includes a digital circuitry configured to provide multiple subcarriers that include data subcarriers and guard band subcarriers. The system further includes a controller configured to perform a plurality of multiplexing operations with the multiple subcarriers to obtain respective output signals. Each multiplexing operation is performed with the one or more subcarriers of the selected group having a variation. The controller is further configured to select an output signal that provides a desired property, and to set an adjustment value for each subcarrier of the selected group based on the multiplexing operation that provided the output signal with the desired property.

In some embodiments, the controller can be further configured to perform a multiplexing operation with the multiple subcarriers to obtain an output signal for amplification, with the multiplexing operation performed with each subcarrier of the selected group being adjusted with the adjustment value.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts an example of a frequency division multiplexing (FDM) scheme where a frequency band includes a plurality of signals based on respective subcarrier tones.

FIG. 2 depicts an example of an orthogonal frequency division multiplexing (OFDM) scheme where a frequency band includes more densely packed subcarriers, such that neighboring pairs of signals based on respective subcarrier tones may overlap.

FIG. 3 depicts subcarrier tones for supporting the signals of the OFDM scheme of FIG. 2.

FIG. 4 shows an example of a subcarrier distribution associated with a 20 MHz OFDM signal for a WLAN application.

FIG. 5 shows an envelope of a typical OFDM signal, in time domain, that can result from the OFDM configuration of FIG. 4.

FIG. 6 shows an example of a complementary cumulative distribution function (CCDF) associated with a property where a small portion of the signal necessitates a high peak to average power ratio (PAPR) value.

FIG. 7 shows an OFDM system having one or more features as described herein.

FIG. 8 shows a process that can be performed by some or all of the OFDM system of FIG. 7.

FIG. 9 shows an example of a subcarrier distribution associated with a 20 MHz OFDM signal for a WLAN application, similar to the example of FIG. 4.

FIG. 10 shows a constellation diagram of magnitude and phase of all subcarriers, including guard band and DC subcarriers.

FIG. 11 shows complementary cumulative distribution function (CCDF) curves resulting from 100 random trials where phase of guard band subcarriers are allowed to vary.

FIG. 12 shows an example impact of a simulation described herein in reference to FIG. 9 and Table 1 in time domain representation.

FIG. 13 shows a comparison of constellation diagrams for a baseline configuration and for an optimal configuration of OFDM.

FIG. 14 shows an improvement of error vector magnitude (EVM) performance from the baseline configuration to the optimal configuration.

FIG. 15 shows that in some embodiments, a semiconductor die having a substrate can include an OFDM system having one or more features as described herein.

FIG. 16 shows that in some embodiments, a module having a packaging substrate can include an OFDM system having one or more features as described herein.

FIG. 17 shows that in some embodiments, a wireless device can include an OFDM system having one or more features as described herein.

### DETAILED DESCRIPTION OF SOME EMBODIMENTS

The headings provided herein, if any, are for convenience only and do not necessarily affect the scope or meaning of the claimed invention.

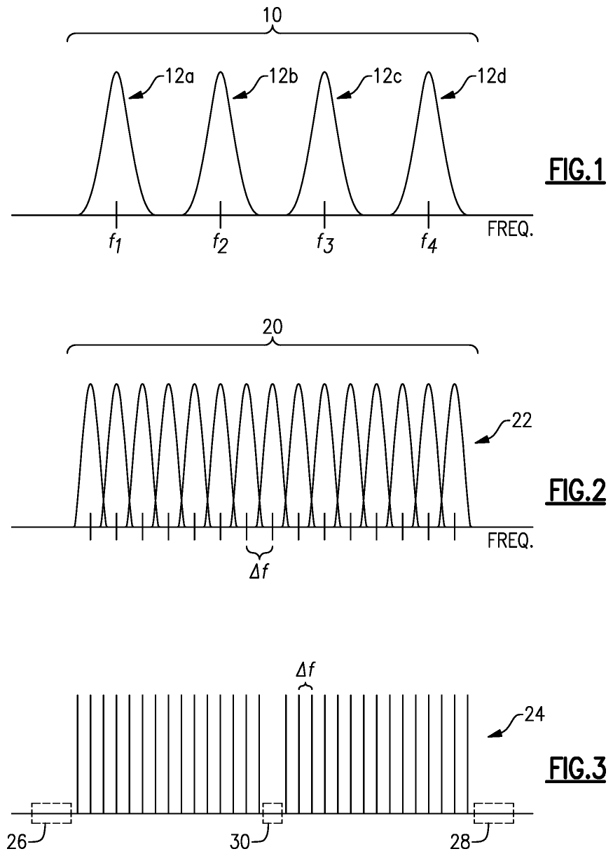

FIG. 1 depicts an example of a frequency division multiplexing (FDM) scheme where a frequency band 10 includes a plurality of signals (e.g., 12a, 12b, 12c, 12d) based on respective subcarrier tones (e.g., center frequencies f₁, f₂, f₃, f₄). In such a multiplexing scheme, the frequencies f₁, f₂, f₃, f₄ are separated sufficiently to avoid overlapping of neighboring signals. Accordingly, there is a limit on how closely subcarriers can be packed within a given frequency band width.

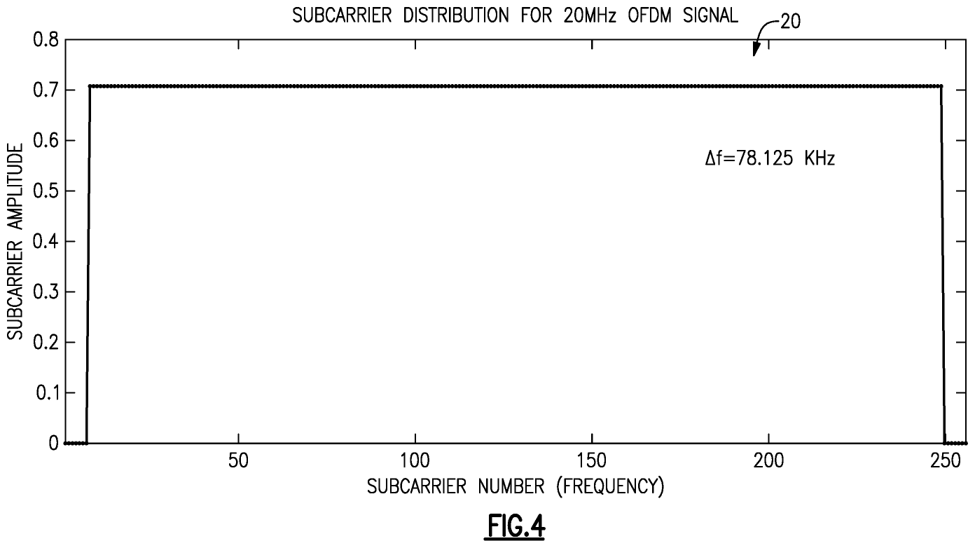

FIG. 2 depicts an example of an orthogonal frequency division multiplexing (OFDM) scheme where a frequency band 20 includes more densely packed subcarriers, such that neighboring pairs of signals 22 based on respective subcarrier tones may overlap. In the example of FIG. 2, each neighboring subcarrier tones is shown to have a frequency spacing of Δf. To accommodate the densely packed subcarriers, each subcarrier can be modulated with, for example, a digital modulation scheme, such that the subcarriers behave as orthogonal subcarriers.

FIG. 3 depicts subcarrier tones 24 for supporting the signals 22 of the OFDM scheme of FIG. 2. Similar to FIG. 2, each pair of neighboring subcarrier tones is shown to have a frequency spacing of Δf.

FIG. 3 further shows that an ODFM scheme can also include guard bands 26, 28 adjacent to the lower and upper frequency limits of the frequency band (20 in FIG. 2). Each of such guard bands can have a width to prevent interference with another frequency band; accordingly, each guard band can include a plurality of tone frequencies spaced by the same Δf. During ODFM operations, such frequencies of the guard bands are typically provided with null amplitudes.

FIG. 3 also shows that an ODFM scheme can also include a DC subcarrier that separates two groups of subcarriers (e.g., first and second data subcarrier groups) within the frequency band (20 in FIG. 2). During ODFM operations, such a DC subcarrier is typically provided with a null amplitude.

The foregoing orthogonal frequency division multiplexing (OFDM) allows a high throughput of data transfer without necessarily relying on a high rate of data transmission. Thus, OFDM is widely used in radio-frequency (RF) applications such as wireless local area network (WLAN) applications (e.g., an 802.11 standard based network) and 5G applications.

It is noted that advantages provided by OFDM can include an ability to achieve very high throughputs, excellent compatibility with multiple-input and multiple-output (MIMO) architecture, and tolerance to multipath and fading that are common in RF environments.

A notable challenge associated with OFDM relates to a very high peak to average power ratio (PAPR) that can result when a large number of subcarriers with different frequencies are combined. For example, OFDM systems can exhibit PAPRs greater than 10 dB. Such a large PAPR can result in inefficient power amplification, since a power amplifier needs to be able to accurately amplify the peaks of the signal. Thus, in the context of the foregoing example where PAPR>10 dB, since the peaks are 10 dB higher than the average power, the power amplifier is typically large and inefficient. Typical power amplifier efficiencies at about 20% are common in OFDM applications, such that a power amplifier having such an efficiency value can consume 5 W to deliver 1 W of RF power to an antenna for transmission.

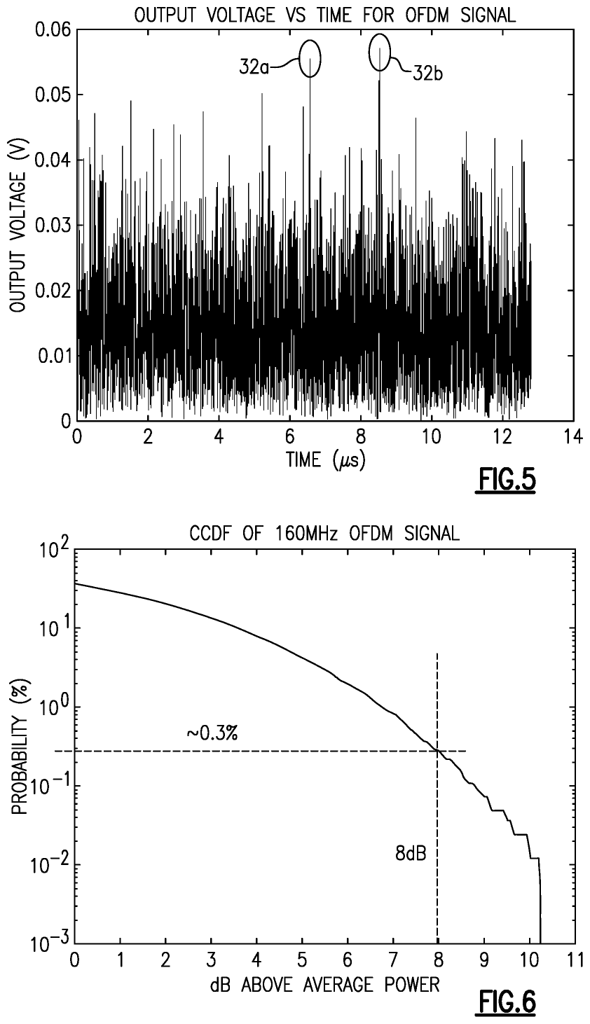

FIGS. 4 to 6 show various examples related to the foregoing power amplification inefficiency problem. FIG. 4 shows an example of a subcarrier distribution 20 associated with a 20 MHz OFDM signal for a WLAN application. Such an example OFDM signal includes a large number of subcarriers that are uniformly distributed in frequency, with a subcarrier spacing of approximately 78.125 kHz. Each subcarrier can be a sinewave with a respective magnitude and phase that are set by the data that is being transmitted. The magnitude and phase of each subcarrier are utilized to encode a respective portion of the transmitted data.

In the example of FIG. 4, there are guard bands at both edges of the channel supporting the subcarrier distribution 20, and such guard bands are configured to provide frequency separation between the channel and another channel. For example, the guard band on the lower frequency edge of the subcarrier distribution 20 can provide frequency separation between the channel and an adjacent channel on the left side of the channel. In another example, the guard band on the upper frequency edge of the subcarrier distribution 20 can provide frequency separation between the channel and an adjacent channel on the right side of the channel. In the example of FIG. 4, all of the subcarriers associated with the guard bands are all provided with zero amplitude.

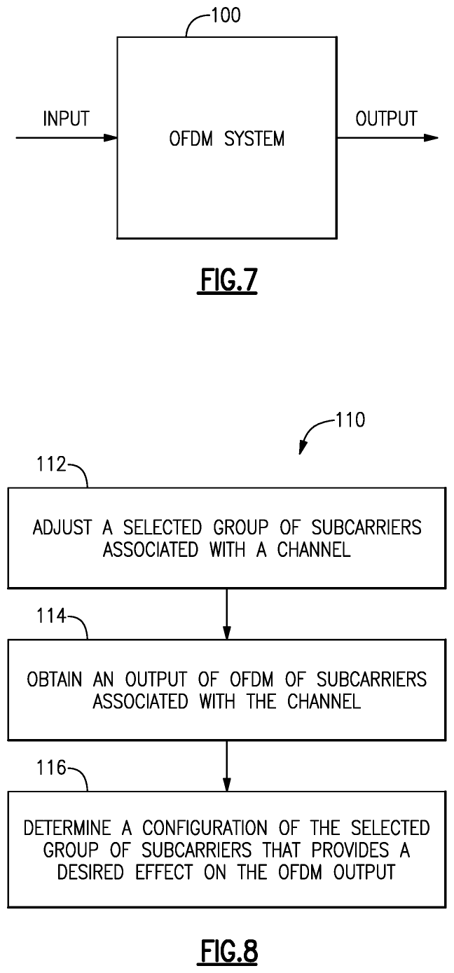

In the example OFDM configuration of FIG. 4, a high PAPR can result when random magnitude and phase of some or all of the subcarriers happen to add in phase to thereby result in constructive interference to produce large peaks in the signal. For example, FIG. 5 shows an envelope of a typical OFDM signal, in time domain, that can result from the OFDM configuration of FIG. 4.

In FIG. 5, large amplitude peaks such as peaks 32a, 32b can result in a high PAPR value for the OFDM signal. It is noted that such large amplitude peaks that produce the high PAPR value only occur for a very small portion of the signal duration time.

The foregoing property of a small portion of the signal that necessitates the high PAPR value can be characterized by a complementary cumulative distribution function (CCDF) as shown in FIG. 6. Such a CCDF provides the probability that any given signal level will exceed the average value. For example, for signal of FIG. 5, the signal is 8 dB higher than the average power approximately 0.3% of the time. In the example of FIGS. 5 and 6, the highest amplitude peak (32b) of the signal is shown to be approximately 10.2 dB in the CCDF of FIG. 6.

It is noted that in some conventional OFDM applications, a clipping technique can be utilized, where any peaks in a signal generated from OFDM are simply clipped at baseband by passing the signal through a limiter. Such a technique typically results in degradation of error vector magnitude (EVM) performance and adjacent channel power ratio (ACPR) performance.

In another example, a conventional approach can include a pulse cancellation crest factor reduction (PC-CFR) technique. Such a technique typically analyzes a time domain data, identifies peak locations, and then adds an inverted pulse, aligned in time to each of the identified peaks of the signal to cancel the peaks. Such a cancelling pulse is typically shaped like a sinc function, and application of such cancelling pulse(s) can reduce the PAPR by about 1 dB to 2 dB.

It is noted that the foregoing cancelling pulse is continuous in time, so application of such a pulse causes only a small amount of adjacent channel leakage ratio (ACLR) degradation. However, application of such a pulse causes a significant degradation in EVM. It is also noted that in OFDM systems involving higher order modulations like 1024 or 4096QAM, such a degradation in EVM is not acceptable or desirable.

In some RF applications where high linearity is desired, an OFDM signal having a high PAPR value is allowed to pass to an analog radio circuit and power amplifier without any clipping. Such a signal typically becomes distorted by the power amplifier, and the power amplifier operates in a very inefficient manner since it needs to handle the high PAPR.

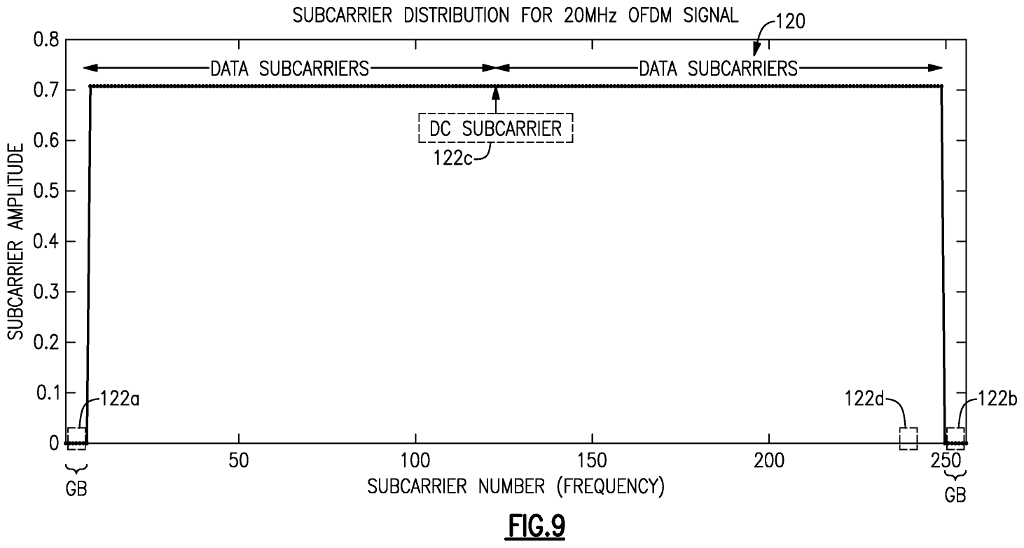

FIG. 7 shows an OFDM system having one or more features as described herein. In some embodiments, such a system can be configured to be provided with an input and generate an output OFDM signal having a desirable property such as a reduced PAPR. Although various examples are described herein in the context of PAPR, it will be understood that one or more features of the present disclosure can also be implemented to provide a desirable property other than PAPR for an output OFDM signal.

FIG. 8 shows a process 110 that can be performed by some or all of the OFDM system 100 of FIG. 7. In process block 112, adjustment can be provided for a selected group of subcarriers associated with a frequency range such as a channel. Examples of such a selected group of subcarriers are described herein in greater detail.

In process block 114, an output of OFDM of subcarriers of the channel can be obtained. In some embodiments, subcarriers being multiplexed includes the selected group having the adjustment.

In process block 116, a configuration of the selected group of subcarriers provides a desired effect on the ODFM output can be determined. In some embodiments, such a configuration of the selected group of subcarriers can be determined by varying one or more subcarrier parameters. Examples related to such variations in subcarrier parameters are described herein in greater detail.

FIG. 9 shows an example of a subcarrier distribution 120 associated with a 20 MHz OFDM signal for a WLAN application, similar to the example of FIG. 4. As in the example of FIG. 4, the subcarrier distribution 120 includes a large number of subcarriers that are uniformly distributed in frequency, with a subcarrier spacing of 78.125 kHz. It is noted that for 5G applications, such a subcarrier spacing can have a value in a range of 15 KHz to 120 KHz. Also as in the example of FIG. 4, there are guard bands at both edges of the channel supporting the subcarrier distribution 120. In the example of FIG. 6, the subcarrier distribution 120 also includes a DC subcarrier provided between two groups of data subcarriers.

It is noted that in the example of FIG. 4, all of the subcarriers associated with the guard bands and the DC subcarrier are provided with zero amplitude. In the example of FIG. 9, such subcarriers associated with the guard bands and the DC subcarrier may or may not be provided with zero amplitude.

FIG. 9 shows that in some embodiments, the selected group of subcarriers reference in FIGS. 7 and 8 can be obtained from one or more subcarriers (indicated as 122a) of the first guard band, one or more subcarriers (indicated as 122b) of the second guard band, one or more DC subcarriers (indicated as 122c), one or more subcarriers (indicated as 122d) within a group of data subcarriers, or any combination thereof.

As an example, some or all of the guard band and DC can be utilized as a selected group of subcarriers to provide a reduction in PAPR as described herein. It is noted that by using the guard bands and DC subcarriers, the throughput of the overall OFDM system will not be affected, since all data subcarriers can still be utilized to carry data.

In some embodiments, the adjustment to the selected group of subcarriers referenced in FIGS. 7 and 8 can include adjustment of magnitude and/or phase of signals being provided to such selected group of subcarriers. As described herein, such utilization of a selected group of subcarriers can result in a significant reduction in the PAPR of the resulting OFDM signal.

It is also noted that since the magnitude and phase of any of the data subcarriers are not being altered, the EVM and ACLR performance parameters are not degraded as is typically seen with baseband clipping or PC-CFR techniques. In fact, since the PAPR is reduced, one can obtain a significant improvement in EVM and ACLR.

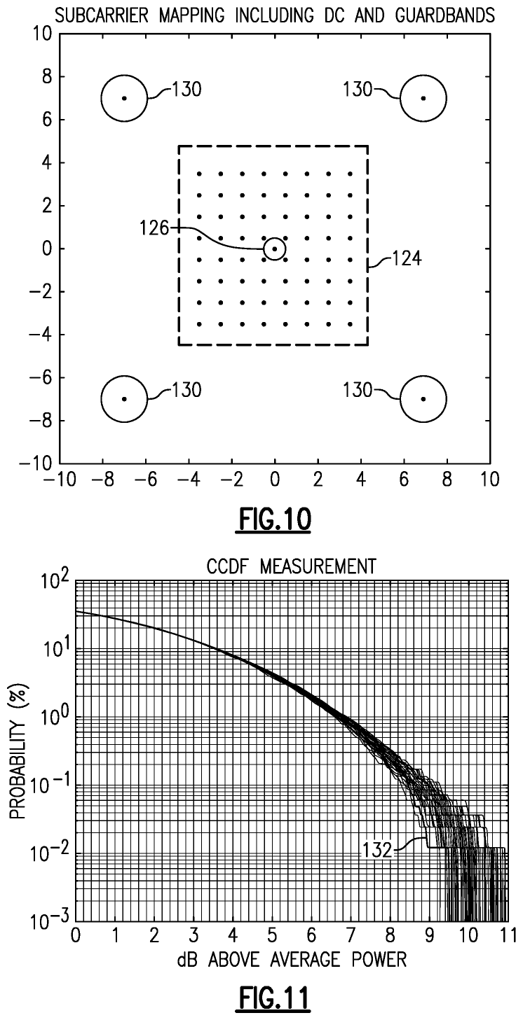

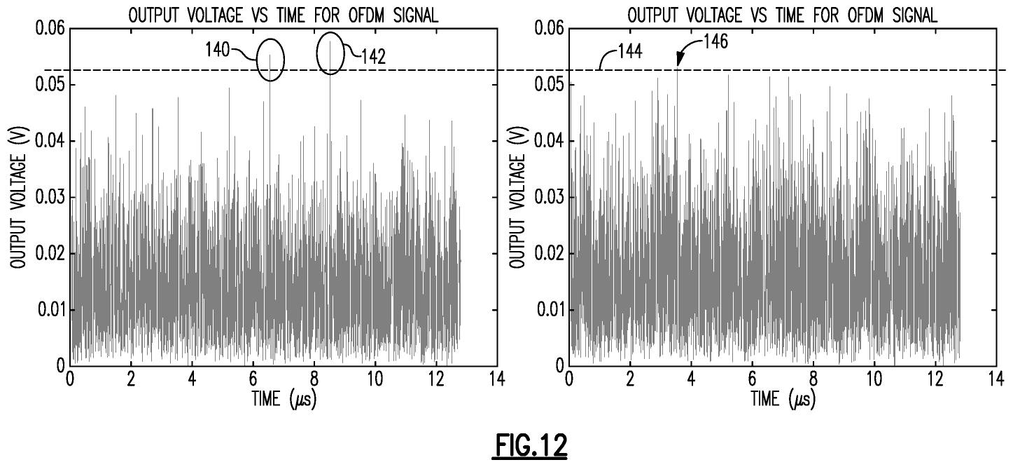

FIGS. 10 to 14 show examples related to a validation process utilizing simulation of the OFDM system of FIGS. 7 and 8, as applied to the example subcarrier distribution 120 of FIG. 9. More particularly, the example subcarrier distribution 120 is for a 160 MHz channel with a total of 1992 data subcarriers a total of 55 guard band subcarriers (28 on the lower frequency side and 27 on the higher frequency side), and one DC subcarrier between first and second groups of data subcarriers.

With the foregoing subcarrier distribution 120, a baseline configuration had none of the guard band subcarriers and the DC subcarrier adjusted, so that all of the guard band subcarriers and the DC subcarrier were provided with zero amplitude. Five different configurations for the selected group of subcarriers having different fractions of guard band subcarriers were provided, as listed in Table 1. In each of such five different configurations, the DC subcarrier was adjusted along with the selected group of subcarriers.

TABLE 1

| Number | Number of | Number | Fraction of | Fraction of total | | | |
|---|---|---|---|---|---|---|---|
| of | guard | of | subcarriers | subcarriers used | | | |
| data | band + DC | subcarriers | adjusted | for selected | | | |
| subcarriers | subcarriers | adjusted | (%) | group (%) | PAPR | EVM | ACLR |
| 1992 | 56 | 0 | 0 | 0 | 10.2 | −37 | −46.6 |
| | | 14 | 25 | 0.7 | 9.4 | −39.2 | −49.2 |
| | | 28 | 50 | 1.4 | 9.4 | −39.2 | −49.5 |
| | | 41 | 75 | 2.1 | 9.2 | −41 | −50.9 |
| | | 50 | 90 | 2.5 | 8.8 | −43.3 | −52.8 |
| | | 55 | 100 | 2.8 | 8.8 | −42 | −28 |

For each of the five adjusted configurations, the maximum amplitude of the subcarrier tones in the selected group of subcarriers was set to be 6 dB higher than the largest subcarrier tone in the data portion of the signal. Further, phase of the subcarrier tones in the selected group of subcarriers was allowed to vary in four steps (45, 135, 225, 315 degrees).

OFDM simulation was performed utilizing a 160 MHz OFDM signal, with 64QAM modulation. As indicated above, guard band subcarriers in selected groups were allowed to be 6 dB higher than data subcarriers (with guard band scaling of 2).

With the foregoing simulation parameters and techniques, 100 random trials were run, where the phase of the guard band subcarriers were allowed to vary. PAPR was measured for each trial, and the trial that gave the lowest PAPR at a CCDF of 2×10⁻³% was selected, and the phase of each subcarrier tone in the selected group was set to the value that provided the lowest PAPR. Table 1 lists the PAPR values resulting from the OFDM simulation.

With the foregoing simulation configurations, the resulting OFDM signal for each of the six configurations (one baseline and five adjusted configurations) was passed through a power amplifier model with a gain of 30 dB and saturated output power of 32 dBm. A Rapp non-linear model was used to simulate the power amplifier with p=6.5. The input signal was adjusted to deliver 24 dBm transmit power from the power amplifier, and EVM and ACLR values were measured. Table 1 lists the resulting EVM and ACLR values resulting from the simulation.

FIGS. 10 to 14 show various results of the simulation discussed above in reference to FIG. 9 and Table 1.

FIG. 10 shows a constellation diagram of magnitude and phase of all subcarriers, including the guard band and DC subcarriers. The data subcarriers are on the 8×8 grid enclosed by a rectangle 124. The subcarriers that have been adjusted (28 guard band subcarriers and 1 DC subcarrier in the example of FIG. 10) are circled as 130, showing that they have a larger magnitude than the data subcarriers. The subcarriers at 0, 0 (27 guard band subcarriers in the example of FIG. 10) are circled as 126, and are the guard band subcarriers that have not been adjusted.

FIG. 11 shows CCDF curves resulting from all of the 100 trials. The heavy line curve indicated as 132 is the CCDF curve with the optimal configuration of the guard band subcarriers (50 guard band subcarriers adjusted to provide the lowest PAPR of 8.8 and the best EVM at −43.3 and the best ACLR at −52.8). As shown in FIG. 11 and indicated in Table 1, the PAPR (of 8.8) has been significantly reduced with this configuration, when compared to the baseline PAPR of 10.2.

FIG. 12 shows the impact of the simulation discussed above in reference to FIG. 9 and Table 1 in time domain representation. More particularly, the left panel shows an envelope of time domain signal resulting from the baseline configuration of OFDM, and the right panel shows an envelope of time domain signal from the optimal configuration of OFDM (50 guard band subcarriers adjusted to provide the lowest PAPR of 8.8 and the best EVM at −43.3 and the best ACLR at −52.8). One can see that in the baseline case, a number of high amplitudes (e.g., peaks 140, 142) are present; whereas in the optimal case, peak amplitudes have been significantly reduced, such that the maximum amplitude level 144 is significantly less than the maximum amplitude level of the baseline case.

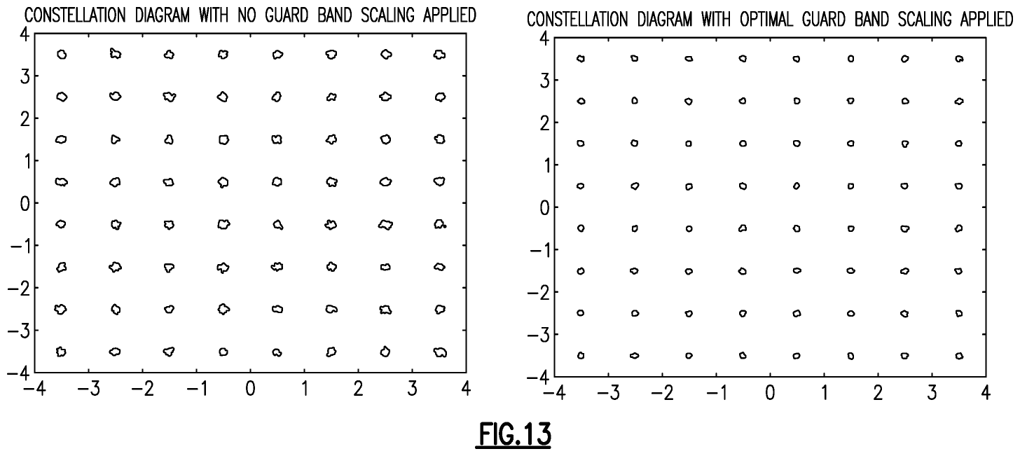

FIG. 13 shows a comparison of constellation diagrams for the baseline configuration (left panel) and for the optimal configuration of OFDM (50 guard band subcarriers adjusted to provide the lowest PAPR of 8.8 and the best EVM at −43.3 and the best ACLR at −52.8). From the comparison, one can see that the EVM is significantly better in the optimal configuration.

As discussed above in reference to FIGS. 10 to 14 and Table 1, best results (among the various configurations) were observed when 90% of the guard bands subcarriers were adjusted. This allowed the PAPR to be reduced by approximately 1.4 dB compared to the baseline case where all guard band subcarriers were set to zero. As also discusses, EVM improved by 5.9 dB from −37.4 dB (baseline) to −43.3 dB (optimal); and ACLR also improved by 6.1 dB from −46.6 dBc (baseline) to −52.7 dBc (optimal).

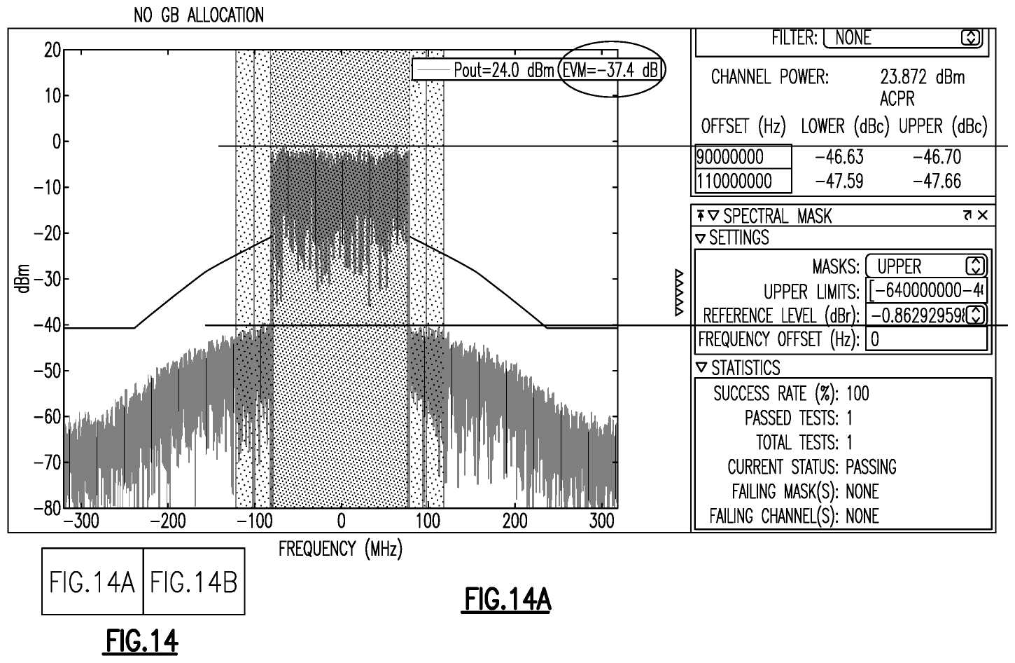

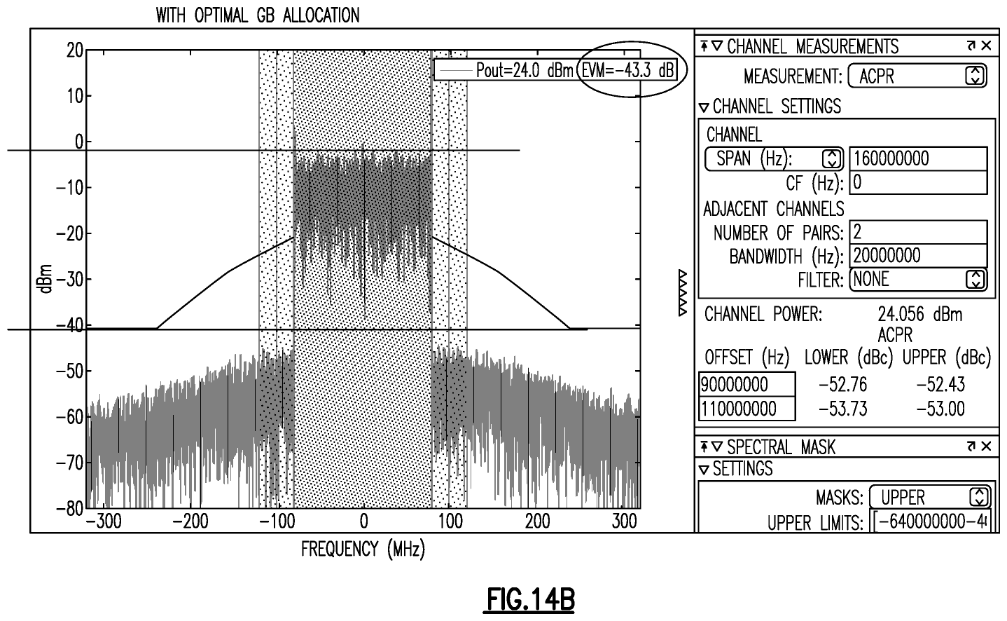

FIG. 14 shows the improvement of the EVM performance from the baseline configuration (left panel) to the optimal configuration (right panel). The lower line shows the improvement seen in the indicated mask.

It is noted that as described herein in reference to Table 1, providing adjustment to a small fraction (e.g., 2.5%) of the total number of subcarriers can result in significant improvements in power amplification related parameters, including a reduction in PAPR. In such an example, one can see that PAPR of an OFDM signal can be reduced significantly, and EVM and ACLR performance can also be improved significantly, even though some energy is being introduced into some or all of the subcarriers of the guard band portion of the spectrum.

It will be understood that while only the phase of the guard band subcarriers is varied in the OFDM system as described herein, one or more other parameters can also be varied. For example, both magnitude and phase of the guard band subcarriers can be varied.

It will also be understood that in some embodiments, a small fraction (e.g., 2.5%) of the data subcarriers can be selected to be adjusted as described herein to provide PAPR reduction, instead of or in addition to using the guard band subcarriers. Use of the guard band subcarriers can be advantageous, since such a configuration does not reduce throughput of the respective OFDM system. However, it will be understood that in some embodiments, similar PAPR, EVM and ACPR improvements can be realized by using selected data subcarriers as well.

It will also be understood that one or more features of the present disclosure can be implemented for any OFDM system, including, for example, WLAN, 4G cellular, 5G cellular, and/or DOCSIS applications.

In some embodiments, one or more features of the present disclosure can be implemented utilizing, for example, algorithms and processors. For example, the validation process described herein in reference to FIGS. 10 to 14 involves computing-intensive algorithms to perform multiple iFFTs for 100 random trials. It will be understood that in some embodiments, other algorithms and/or computing configurations can also be utilized to involve fewer iFFTs. For example, one could consider using only five possible fixed combinations of guard band subcarrier magnitudes and phases, and choosing the best of the five as an optimal configuration. Such an approach may result in less PAPR reduction; however, it would reduce computing complexity and/or requirement.

As another example, one or more peaks can be identified in a time domain signal, and phase of a select number (e.g., 10) of subcarriers (e.g., guard band subcarriers) could be computed so that the resulting time domain signal includes anti-phase peak(s) corresponding to the one or more identified peaks of the original time domain signal. Such anti-phase peak(s) can cancel some or all of the one or more identified peaks, thereby reducing the peak amplitude(s) of the time domain signal. The foregoing process can be repeated for other, smaller peaks seen in the original, uncorrected, time domain waveform. It should be noted that this approach is fundamentally different from a PC-CFR, since this approach utilizes dedicated subcarriers (e.g., non-data subcarriers) to control the peaks, rather than adding a pulse in the time domain (that necessarily involves a large number of subcarriers and thereby degrade EVM performance).

It will be understood that other algorithms may also be utilized.

It is noted that in United States, Federal Communications Commission (FCC) has adopted a power spectral density (PSD) limit for Low Power Indoor (LPI) operation in the 6 GHz band, with maximum PSD of 5 dBm/MHz. Since the subcarriers in the examples provided herein are spaced apart by 78.125 kHz, using a number of high-amplitude subcarriers (e.g., greater than or equal to 12) may result in a measurable increase in PSD (e.g., 12×78.125=937.5 kHz), and such an increase is a significant fraction of the 1 MHz RBW used for PSD measurements.

For LPI operations, the foregoing increase in PSD may reduce the maximum allowed transmit power. Thus, in some embodiments, a OFDM system can be configured to ensure that the maximum number of contiguous subcarriers used for PAPR reduction is, for example, three (e.g., 3×78.125 kHz=0.2 MHz), so the PSD impact of using high amplitude subcarriers will be significantly reduced. However, since it may be desirable to use as many as 50 subcarriers for PAPR reduction (assuming 160 MHz bandwidth), such number of subcarriers can be distributed across the entire band, including some in data carrying subcarriers. Such use of data carrying subcarriers for PAPR reduction can be based on some standardized scheme where some data subcarriers are reserved for PAPR reduction, and may have a slight impact on throughput.

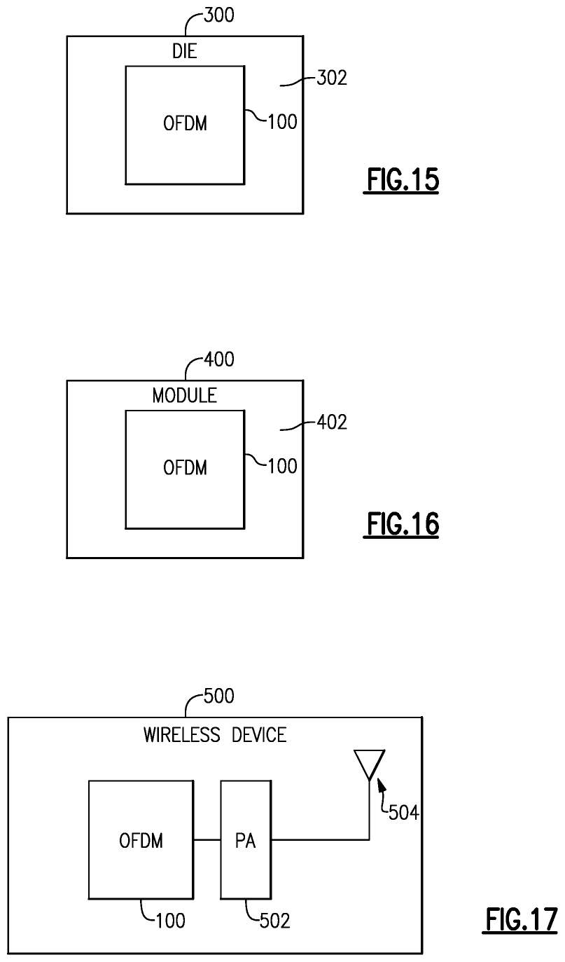

FIGS. 15 to 17 show examples of various products where one or more features of the present disclosure can be implemented. For example, FIG. 15 shows that in some embodiments, a semiconductor die 300 having a substrate 302 can include an OFDM system 100 having one or more features as described herein.

In another example, FIG. 16 shows that in some embodiments, a module 400 having a packaging substrate 402 can include an OFDM system 100 having one or more features as described herein. Such an OFDM system may or may not be implemented on a common die.

In yet another example, FIG. 17 shows that in some embodiments, a wireless device 500 can include an OFDM system 100 having one or more features as described herein. In some embodiments, such and OFDM system can be implemented to provide a multiplexed signal with a reduced PAPR to a power amplifier 502. An amplified signal from the power amplifier 502 can be transmitted through an antenna 504.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A method for multiplexing signals, the method comprising:
providing multiple subcarriers;
selecting a group of one or more subcarriers among the multiple subcarriers;
adjusting each subcarrier of the selected group; and
performing a multiplexing operation with the multiple subcarriers to obtain an output signal, the output signal having an adjusted property resulting from the adjusting of the one or more subcarriers of the selected group.

2. The method of claim 1 wherein the multiple subcarriers include one or more groups of data subcarriers and one or more groups of guard band subcarriers.

3. The method of claim 2 wherein the one or more groups of data subcarriers include first and second groups of data subcarriers.

4. The method of claim 3 wherein the selected group includes some or all of the guard band subcarriers.

5. The method of claim 4 wherein the multiple subcarriers further include a DC subcarrier implemented between the first group of data subcarriers and the second group of data subcarriers.

6. The method of claim 5 wherein the selected group further includes the DC subcarrier.

7. The method of claim 4 wherein the selected group does not include any data subcarriers.

8. The method of claim 4 wherein the selected group includes a portion of the data carriers.

9. The method of claim 2 wherein the adjusting of each subcarrier of the selected group includes providing a non-zero amplitude and a phase to each subcarrier of the selected group.

10. The method of claim 9 wherein the non-zero amplitude includes a fixed amplitude for all of the subcarriers of the selected group.

11. The method of claim 9 wherein the non-zero amplitude is selected to be greater than the largest amplitude among the data subcarriers.

12. The method of claim 9 wherein the phase provided to each subcarrier of the selected group includes a selected phase obtained from an iterative process where phase is allowed to vary, the selected phase corresponding to an output having a desired property resulting from a multiplexing operation with the selected phase provided for each subcarrier of the selected group.

13. The method of claim 9 wherein the non-zero amplitude and the phase provided to each subcarrier of the selected group are tailored to generate one or more peaks in a time domain signal with each peak having a phase that cancels some or all of a corresponding peak identified in an uncorrected time domain signal.

14. The method of claim 2 wherein the adjusted property of the output signal includes an adjusted peak to average power ratio (PAPR).

15. The method of claim 14 wherein the adjusted PAPR includes a reduced PAPR.

16. The method of claim 15 further comprising providing the output signal with the reduced PAPR to a power amplifier to obtain an amplified signal.

17. The method of claim 16 wherein the amplified signal is obtained with some or all of an improved power amplification efficiency, an improved error vector magnitude (EVM) performance, and an improved adjacent channel power ratio (ACPR) performance, when compared to an amplified signal resulting from amplification of an output of a multiplexing operation without adjustment of the one or more subcarriers of the selected group.

18. The method of claim 2 wherein the multiplexing operation includes an orthogonal frequency division multiplexing (OFDM) operation.

19. A method for determining an adjustment for a multiplexing operation, the method comprising:
selecting a group of one or more subcarriers among multiple subcarriers including data subcarriers and guard band subcarriers;
performing a plurality of multiplexing operations with the multiple subcarriers to obtain respective output signals, each multiplexing operation performed with the one or more subcarriers of the selected group having a variation;
selecting an output signal that provides a desired property; and
setting an adjustment value for each subcarrier of the selected group based on the multiplexing operation that provided the output signal with the desired property.

20. (canceled)

21. (canceled)

22. A multiplexing system comprising:
a digital circuitry configured to provide multiple subcarriers that include data subcarriers and guard band subcarriers; and
a controller configured to adjust each subcarrier of a selected group of one or more subcarriers among the multiple subcarriers, and perform a multiplexing operation with the multiple subcarriers to obtain an output signal, such that the output signal has an adjusted property resulting from the adjustment of the one or more subcarriers of the selected group.

23. (canceled)

24. (canceled)

25. (canceled)
